(19) United States
(12) Patent Application Publication
(10) Pub. No.: US 2024/0017186 A1
(43) Pub. Date: Jan. 18, 2024

(54) LIQUID DISTILLATION DEVICE

(71) Applicant: Christopher Link, Seneca, SC (US)

(72) Inventor: Christopher Link, Seneca, SC (US)

(21) Appl. No.: 18/353,061

(22) Filed: Jul. 14, 2023

Related U.S. Application Data
(60) Provisional application No. 63/389,229, filed on Jul. 14, 2022.

(51) Int. Cl. B01D 1/22; B01D 1/00; B01D 5/00; B01D 1/30

(52) U.S. Cl. CPC B01D 1/223; B01D 1/0094; B01D 5/0015; B01D 5/006; B01D 5/009; B01D 1/305

(57) ABSTRACT

Aspects of the present disclosure may provide a liquid distillation apparatus comprising: one or more liquid distillation modules, each liquid distillation module comprising: a one cold wall having a front side and an opposed back side positioned adjacent to a warm wall having a front side and an opposed back side; the warm wall back side and an adjacent cold wall front side defining a first zone therebetween, and the cold wall back side and an adjacent warm wall front side defining a second zone therebetween; a circulation system comprising: a shaft disposed through each of the one or more distillation modules; a plurality of protrusions evenly distributed on one plane and disposed orthogonally on the shaft, and a motor configured to exert a rotational force on the shaft.

### CROSS REFERENCE TO RELATED APPLICATIONS

This application claims the benefit of priority to U.S. Provisional Patent Application Ser. No. 63/389,229, filed Jul. 14, 2022, which is hereby incorporated herein by reference in its entirety.

### FIELD OF DISCLOSURE

The present disclosure generally relates to devices, apparatuses, systems, and methods for liquid purification, distillation, and desalination.

### BACKGROUND

In some situations, access to drinking water may be limited. For example, freshwater streams, aquifers, and/or wells may be restricted or in short supply in regions of economically underdeveloped countries, while saltwater or other forms of non-drinkable water may be plentiful. The conventional strategy for treating non-drinkable water is the use of desalinating, distilling, and/or purifying water devices. However, problems often exist because the conventional strategy does not account for the scalability, efficiency, and costs to build and maintain these types of devices.

Accordingly, there remains a need for an improved device, system, and method for desalinating, purifying, and distilling water that is cost-effective and easily allows installation, deployment, and operation. This need and other needs are satisfied by the various aspects of the present disclosure.

### SUMMARY OF THE INVENTION

In accordance with the purposes of the invention, as embodied and broadly described herein, the invention, in one aspect, relates to a device, system and method for purification, distillation, and desalination of liquids, for example, water. This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

In further aspects, the invention relates to a liquid distillation apparatus comprising: one or more liquid distillation modules, each liquid distillation module comprising: a one cold wall having a front side and an opposed back side positioned adjacent to a warm wall having a front side and an opposed back side; the warm wall back side and an adjacent cold wall front side defining a first zone therebetween, and the cold wall back side and an adjacent warm wall front side defining a second zone therebetween; a first drift eliminator arrangement including inner and outer drift eliminator portions, the first drift eliminator arrangement positioned in the first zone; a secondary drift eliminator arrangement including inner and outer drift eliminator portions, the secondary drift eliminator arrangement positioned in the second zone; a cold liquid source configured to disperse cold liquid onto a cold wall front face; a warm liquid source being configured to disperse warm liquid onto the warm wall front face; a distilled liquid receptacle configured to collect distilled liquid resultant from liquid droplets being separated from liquid vapor, the liquid vapor having navigated through the first drift eliminator arrangement and the second drift eliminator, a waste liquid receptacle configured to collect a waste liquid resultant of non-distilled liquid; a circulation system comprising: a shaft disposed through each of the one or more distillation modules; a plurality of protrusions evenly distributed on one plane and disposed orthogonally on the shaft, and a motor configured to exert a rotational force on the shaft, wherein rotation of the shaft causes the following: a shear force exerted on liquid encountering one of the rotating protrusions, a heat exchange facilitated by the circulation and/or between cold liquid vapor formed from the rotating protrusion of the circulation system with the cold liquid source and warm liquid vapor formed from the warm liquid source; and an external housing containing: the one or more liquid distillation modules, and the shaft, and the plurality of protrusions.

Aspects of the present disclosure may provide a liquid distillation apparatus comprising: one or more liquid distillation modules, each of the one or more liquid distillation device comprising: a cold wall comprising: a cold wall aperture oriented in the middle of the cold wall, a cold wall front side comprising a second drift eliminator outer portion dimensioned proportionally to the cold wall and spanning the perimeter of the cold wall, and a cold wall back side comprising a first drift eliminator outer portion dimensioned proportionally to the cold wall aperture and spanning the perimeter of the cold wall aperture, a cold liquid introduction system spanning a top edge of the cold wall front side, the cold liquid introduction system being configured to disperse cold liquid onto the cold wall front face, a distilled liquid receptacle spanning a bottom edge of the cold wall front side, the distilled liquid receptacle being configured to receive distilled liquid resultant from liquid droplets being separated from liquid vapor, the liquid vapor having navigated through one or more of the first drift eliminator and the second drift eliminator, a warm wall comprising: a warm wall aperture oriented in the middle of the warm wall, the warm wall aperture housing a first drift eliminator outer portion, a warm wall front side, and a warm wall back side comprising a second drift eliminator inner portion dimensioned proportionally to the, a warm liquid introduction system spanning a top edge of the warm wall front side, the warm liquid introduction system being configured to disperse warm liquid onto the warm wall front face, a waste liquid receptacle spanning a bottom edge of the warm wall front side, the waste liquid receptacle being configured to receive a waste liquid resultant of non-distilled water collecting at the bottom of the apparatus; a circulation system comprising: a shaft disposed through the following: each of the cold wall apertures, each of the warm wall apertures, and for each of the one or more liquid distillation modules, a plurality of protrusions evenly distributed on one plane and disposed orthogonally on the shaft, a motor configured to exert a rotational force on the shaft, wherein rotation of the shaft causes the following: a shear force exerted on liquid encountering one of the rotating protrusions, a heat exchange between cold liquid vapor formed from the rotating circulation system with the one or more cold liquid introduction systems and warm liquid vapor formed from the one or more warm liquid introduction systems; and an external housing enveloping the following: the one or more liquid distillation modules, and the shaft, and the plurality of protrusions.

Also disclosed herein are methods for using the disclosed devices for distilling water and liquids.

Additional aspects of the invention will be set forth in part in the detailed description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are illustrative and explanatory only and are not restrictive of the invention, as claimed. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 is a first perspective view of a liquid distillation device showing;

FIG. 2 is an exploded perspective view thereof;

FIG. 3 is another perspective view thereof; and

FIG. 4 is an exploded perspective view thereof.

FIG. 5 is a flow chart of a method for distilling water using a disclosed distillation device in accordance with an illustrative embodiment of the present disclosure.

FIG. 6 shows a diagram of a system including a computing device for enabling operation of the disclosed devices in accordance with another exemplary embodiment of the present invention.

### DETAILED DESCRIPTION

The present invention can be understood more readily by reference to the following detailed description of the invention and the examples included therein. Before the present articles, systems, apparatuses, devices, and/or methods are disclosed and described, it is to be understood that they are not limited to specific manufacturing methods unless otherwise specified, or to particular materials unless otherwise specified, as such can, of course, vary. It is also to be understood that the terminology used herein is for the purpose of describing particular aspects only and is not intended to be limiting. Although any methods and materials similar to or equivalent to those described herein can be used in the practice or testing of the present invention, example methods and materials are now described.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

### Definitions

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this invention belongs. In this specification and in the claims, which follow, reference will be made to a number of terms which shall be defined herein.

As used in the specification and the appended claims, the singular forms “a,” “an” and “the” include plural referents unless the context clearly dictates otherwise. Thus, for example, reference to “a module” includes two or more modules.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally affixed to the surface” means that it can or cannot be fixed to a surface.

Disclosed are the materials, components, parts, and/or elements to be used to manufacture the disclosed devices and systems of the invention as well as the materials themselves to be used within the methods disclosed herein. These and other materials are disclosed herein, and it is understood that when combinations, subsets, interactions, groups, etc. of these materials are disclosed that while specific reference of each various individual and collective combinations and permutation of these materials cannot be explicitly disclosed, each is specifically contemplated and described herein. For example, if a particular material is disclosed and discussed and a number of modifications that can be made to the materials are discussed, specifically contemplated is each and every combination and permutation of the material and the modifications that are possible unless specifically indicated to the contrary. Thus, if a class of materials A, B, and C are disclosed as well as a class of materials D, E, and F and an example of a combination material, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the articles and devices of the invention. Thus, if there are a variety of additional steps that can be performed it is understood that each of these additional steps can be performed with any specific aspect or combination of aspects of the methods of the invention.

It is understood that the devices and systems disclosed herein have certain functions. Disclosed herein are certain structural requirements for performing the disclosed functions, and it is understood that there are a variety of structures that can perform the same function that are related to the disclosed structures, and that these structures will typically achieve the same result.

Furthermore, when used herein to join a list of items, “or” denotes “at least one of the items,” but does not exclude a plurality of items of the list. Finally, when used herein to join a list of items, “and” denotes “all of the items of the list.”

The following detailed description also refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of liquid purification, distillation, and desalination, embodiments of the present disclosure are not limited to use only in this context.

### I. Device and Apparatus Overview

As briefly described above, the present disclosure provides, in various aspects, a method, device and system for purification, distillation, and desalination of liquids, for example, such as water. In one aspect, the apparatus, which also may be referred to herein as a device, may be thought of or otherwise configured as a “contained hurricane” turned on its side. In further aspects, during operation, thermal energy is exchanged between vapors of different temperatures. In yet further aspects, vapors are introduced from isolation and the exchange is facilitated by shear forces caused by the rotating shaft, which can induce condensation. As used herein, the terms purification, distillation, desalination, and iterations thereof may be used interchangeably.

This overview is provided to introduce a selection of concepts in a simplified form that are further described below. This overview is not intended to identify key features or essential features of the claimed subject matter. Nor is this overview intended to be used to limit the claimed subject matter's scope.

In various aspects, embodiments of the present disclosure may provide a liquid purification, distillation, and desalination device including modules with a number of walls in close proximity to one another. In further aspects, a wall may have warm water and/or cold water introduced down one side of the wall. In still further aspects, the cold water walls and the warm water walls configuration within the housing may be evenly staggered.

In yet further aspects, a circulator or circulation system may be employed for moving air and/or vapor. In even further aspects, the circulation system, or a portion thereof, may be located between these warm and cold walls may be configured as a circulator having spokes or blades evenly distributed. The circulator may be used to aid in heat exchange and cause further shear forces on droplets of water vapor disposed between the walls. When liquid water is formed, the vapor and gases then may travel through a series of drift eliminators which rapidly force changes in the velocity of the vapor droplets, thereby separating the distilled liquid in the vapor from the gas. The distilled vapor may then utilize gravity to eventually collect in a distilled liquid receptacle which may then be removed or pumped out of the apparatus. Put another way, the cold liquid wall may act as a condenser. There may be a gap between the walls and the housing containing the apparatus to allow for of gas circulation around the walls.

Embodiments of the present disclosure generally comprise methods, systems, devices, apparatuses, and components comprising, but not limited to, at least one of the following: a housing; a least one distillation modules; and a circulation system.

In further aspects, each liquid distillation module generally comprises a one cold wall having a front side and an opposed back side positioned adjacent to a warm wall having a front side and an opposed back side. The space between the cold and warm walls define one or more difference zones. For example, the warm wall back side and an adjacent cold wall front side may define a first zone therebetween, and the cold wall back side and an adjacent warm wall front side may define a second zone therebetween. One of the zones may contain rotating spokes and may be a condensing zone.

In still further aspects, there may a first drift eliminator arrangement including inner and outer drift eliminator portions. The first drift eliminator arrangement may positioned in the first or second zone;

There may be a secondary drift eliminator arrangement including inner and outer drift eliminator portions. The secondary drift eliminator arrangement may be positioned in the second zone. Additional first and secondary drift eliminator arrangements may be configured sequentially to appear in adjacent zones.

In further aspect, apparatus may comprise a cold liquid source configured to disperse cold liquid onto a cold wall front face and a warm liquid source being configured to disperse warm liquid onto the warm wall front face. The water source may be configured as a circulation system with piping and tubing as disclosed herein.

In still further aspects, the distillation module may comprise a distilled liquid receptacle configured to collect distilled liquid, for example, distilled liquid resultant from liquid droplets being separated from liquid vapor, the liquid vapor having navigated through the first drift eliminator arrangement and the second drift eliminator. In yet further aspects, the distillation module may comprise a waste liquid receptacle configured to collect a waste liquid resultant of non-distilled liquid.

In further aspects, the apparatus may comprise a circulation system for moving air and vapor to increase the rate of collisions. The circulation system may comprise a shaft disposed through each of the one or more distillation modules and walls; a plurality of protrusions evenly distributed on one plane and disposed orthogonally on the shaft, and a motor configured to exert a rotational force on the shaft. To this end, rotation of the shaft may be effective to cause the following: a shear force exerted on liquid encountering one of the rotating protrusions, a heat exchange facilitated by the circulation and/or between cold liquid vapor formed from the rotating protrusion of the circulation system with the cold liquid source and warm liquid vapor formed from the warm liquid source.

According to various aspects of the present disclosure, a device and system of the present invention comprises a housing, which may be shaped to conform to the contour of a flat surface, such as, for example, a surface of a table or floor. In further aspects, the housing may have an established shape, for example, by a preformed housing or frame, or can be a moldable or foldable housing. In still further aspects, a housing may be flat in shape on at least its proximal side (i.e., side facing or contacting the mounting surface) so that the contact area is shaped so that all or substantially all of the proximal side or rear face of the housing contacts or is otherwise disposed on the adjacent surface. All or a portion of a housing may be flat. Additionally, in other embodiments, at least a proximal side and/or a distal side of the housing may be flat or planar, and the lateral sides of the casing may be shaped. In still further aspects, all the plurality sides of the housing may be flat or planar. The housing can be any shape, and preferably is in the shape of a three-dimensional polygon, for example, a rectangular cube. The housing sides or walls define an interior compartment space or interior sections for containing the distillation module and components, and/or certain operating elements of the invention. Any other shape (as used herein, the term shape is used in the broad sense of three-dimensional works) may be employed, so long as the shape is large enough and structured so as to be able to contain modules, components, and various working components of the invention as more fully disclosed below.

In further aspects, the housing is a generally hollow structure sized to contain distillation modules, components and operating elements disposed therein. The housing can be a rigid hollow shell or open container having an interior compartment space to volume. The housing may be constructed such that housing can contain and hold various working components in a predetermined position relative to the outer walls or an opening on the housing for accessing the interior compartment space or volume. In further aspects, the housing may comprise at least one housing door. The housing door may define at least one side of the housing and configured to provide access to the interior compartment space. In further aspects, some or all of the device components can be housed within the housing such that vacuum can be created and they are protected from, for example, the environmental elements. In even further aspects, the housing can be comprised of plastic, plastic composite, reinforced plastic, metal, metal composite, or combinations thereof. In still further aspects, the plastic can comprise polypropylene, impact resistant plastic, or the like. In some aspects, the housing may comprise a plastic housing. In other aspects, the housing may comprise a metal housing. In yet other aspects, the housing may be a combination of material and colors. The housing may be a planar plate that is molded or folded into an open container allowing for ease of inserting and removing items in the interior compartment space. In some embodiments, the housing door or wall may be clear, translucent, transparent, or sufficiently see-through to allow viewing of the contents contained in the interior compartment space.

In some embodiments, the present disclosure may provide an additional set of components for further facilitating the system. In further aspects, the apparatus and system may include at least one of: a separation module and a water feed module configured to dispense water into the system. A separation module may comprise one or more of: a separation module, condenser, and/or measuring pipe, or combinations thereof. A water feed module may comprise a water source and pump, conveyor, or combinations thereof. In further aspects, the device further comprises a control unit in operative communication with the device components, units, and/or modules for controlling operation of the device or system. In some aspects, the invention may employ a microcontroller and circuitry for connecting the various components, units, and/or modules. The device or control unit may further comprise a user interface for communicating with and/or allowing a user to interact with the device. The user interface may comprise buttons, switches, an LCD screen and/or any I/O devices, such as knobs, dials or the like, capable of communicating with the end user and/or controlling one or more functions of the device. In various aspect, the system and device may use various technologies in connection with performing different operational functions, including, but not limited to, artificial intelligence (AI), machine vision, machine learning techniques, predictive modeling/analytics and/or various algorithms. For example, the system and device may use various algorithms, predictive analytics, AI and machine learning techniques to scan the interior and determine vapor patterns and device performance.

In further aspects, the disclosed devices and systems may further comprise one or more of the following components: sensors, pumps, switches, buttons, displays, imaging sensors, audio module, voice module, memory module, sensors, power management module, antenna (e.g., Bluetooth LE antenna), transceiver (e.g., Bluetooth LE transceiver), lights, motor controller, input module, interface module, control module, voltage sensor, current sensor, power input, magnetic switch, motor control module (e.g., actuator control module), and motor drive, and the like. In still further aspects, a number of internal components may be mounted within an interior or exterior portion of the device and/or housing. For example, in some embodiments, the device may have an internal component configuration further comprising sensors, and exterior component configuration comprising a motor or drive unit.

In further aspects, each of the rotatable spokes of the mechanical rotating circulator are configured to pivotably rotate about an axis. Each of the zones and rotatable members may comprise specific component characteristics and configuration, such as, for example, size and dimensions, that can be configured to adjust for intended function, and other factors to achieve optimal process parameters, reaction products and/or product yield. In further aspects, features of the system and components may be configured or utilized to set and/or control the characteristics. For example, at least one of the following may be configured: the type of material used for the components; the member or protrusion dimensions (e.g., height, width, thickness, shape, fin or surface profile, etc.); location of the member; and the like.

In further aspects, while certain components of the disclosed system described herein can be permanently mounted in or on a component, this is not a requirement. For example, the distillation module walls and rotatable spoke member can be configured to be removably attached to the shaft, e.g., to allow interchange and/or replacement rotatable members in each zone. Such configurations allow workers, or others to select desired properties or levels in a zone, e.g., for customization purposes, for process preferences, to match desired use conditions, liquid characteristics, or to repair or replace defective or damaged components, etc. Further, since the mechanical rotating device can be configured to be removably installed in existing process vessels, the present disclosure also provides a retrofittable integrated reactor comprising the components of the integrated reactor apparatus, such as the mechanical rotating device.

In various aspects, the components of the disclosed system and components can be detachably attached. In further aspects, the components can be connected by a connecting means. In still further aspects, the connecting means can comprise a fitting, insert, adhesive, brazing, soldering, welding, spot weld, screw with nut, rivet, threading, friction fit, snap-fit, twist-lock, or interlocking mechanism or a combination thereof. In yet further aspects, the connection can be achieved using a snap, friction fitting, snap ring, O-ring, pressure fitting, clip, clasp, and the like. The snap ring or O-ring can be retained within a groove to accommodate the snap ring or O-ring. In a further aspect, the system can comprise an engagement means for coupling and holding components together. In a further aspect, the engagement means can be a screwing mechanism, a click-lock mechanism, or friction mechanism, or the like. In still further aspects, the system components can be integrally or mechanically attached to other components. In a yet further aspect, the disclosed components can be connected, attached, or mounted using a connecting means, the connecting means comprising a fitting, insert, adhesive, brazing, soldering, welding, spot weld, screw with nut, rivet, fitting, insert, threading, friction fit, or snap-fit or a combination thereof.

In various aspects, advantages of the disclosed apparatuses and systems employing the disclosed distillation module construction and circulation device include at least one of: Lower total process energy requirements; Expected higher product yield; Lower heat losses; Improved process temperature control; Simplified system and operation; Smaller system footprint; and Lower equipment and installation cost.

Details with regards to each component are provided below. Although components are disclosed with specific functionality, it should be understood that functionality may be shared between components, with some functions split between components, while other functions duplicated by the components. Furthermore, the name of the component should not be construed as limiting upon the functionality of the component. Moreover, each stage disclosed within each component can be considered independently without the context of the other stages within the same component or different components. Each stage may contain language defined in other portions of this specifications. Each stage disclosed for one component may be mixed with the operational stages of another component. In the present disclosure, each stage can be claimed on its own and/or interchangeably with other stages of other components.

### II. System Configuration

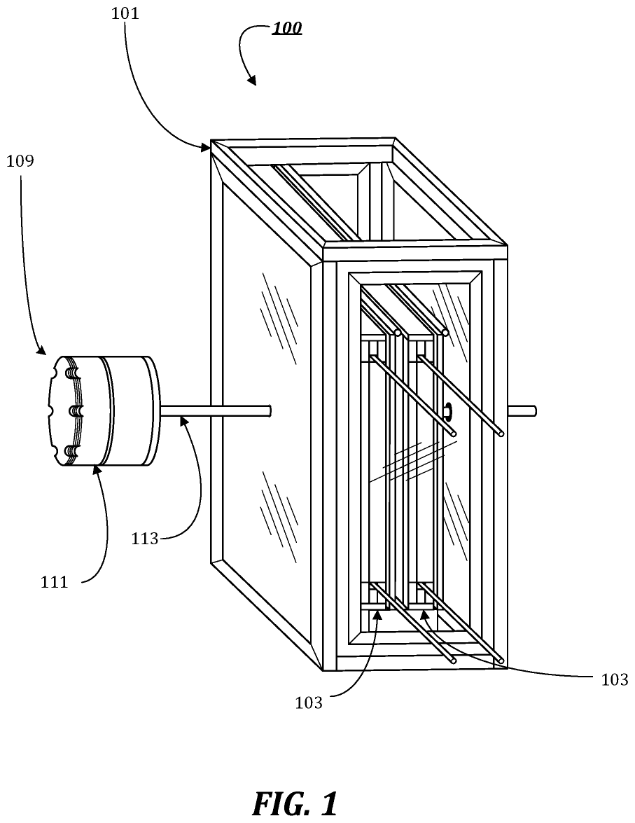

According to various aspects of the invention, the methods, apparatuses, devices, and systems of the present disclosure can comprise multiple configurations. FIGS. 1-6 illustrate non-limiting examples of embodiments of operating environments, mechanisms, and components for the disclosed devices and systems. Although the operating environments, mechanisms, and components are disclosed with specific functionality, it should be understood that functionality may be shared between mechanisms and/or components, with some functions split between mechanisms and/or components, while other functions duplicated by the mechanisms and/or components. Furthermore, the name of the mechanisms and/or components should not be construed as limiting upon the functionality of the mechanisms and/or components. Moreover, each stage in a method or claim language can be considered independently without the context of the other stages. Each stage may contain language defined in other portions of this specifications. Each stage disclosed for one mechanism and/or component may be mixed with the operational stages of another mechanism and/or component. Each stage can be claimed on its own and/or interchangeably with other stages of other mechanisms and/or components.

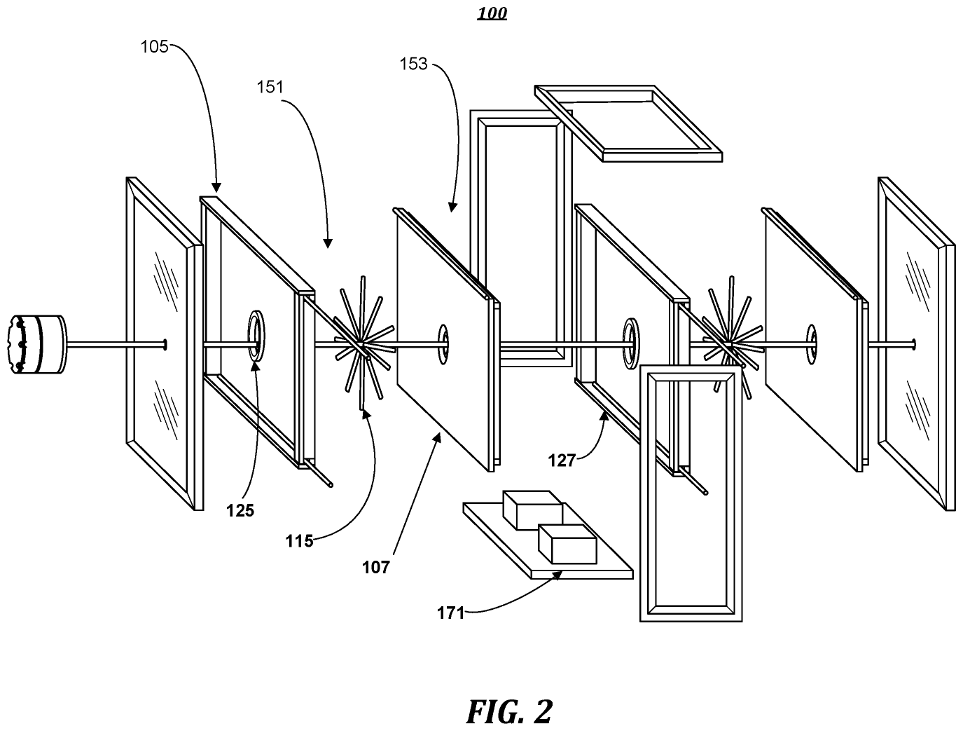

FIGS. 1-2 show various views of an illustrative embodiment of a liquid distillation apparatus 100 in accordance with the present invention. Apparatus 100 includes an external housing 101; a pair of distillation modules 103, each including a cold wall 105 and a warm wall 107; and a circulation system 109 including a motor 111 for driving a rotatable shaft 113 with spokes 115 extending orthogonally out.

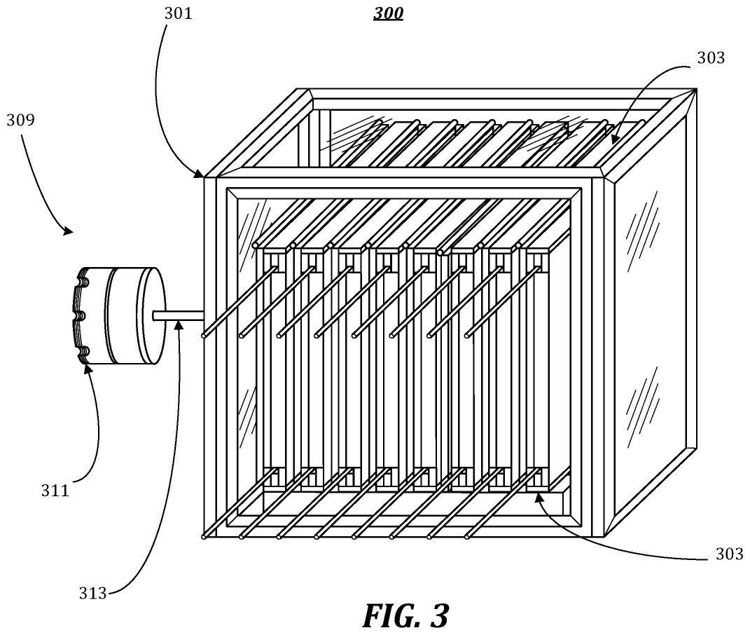

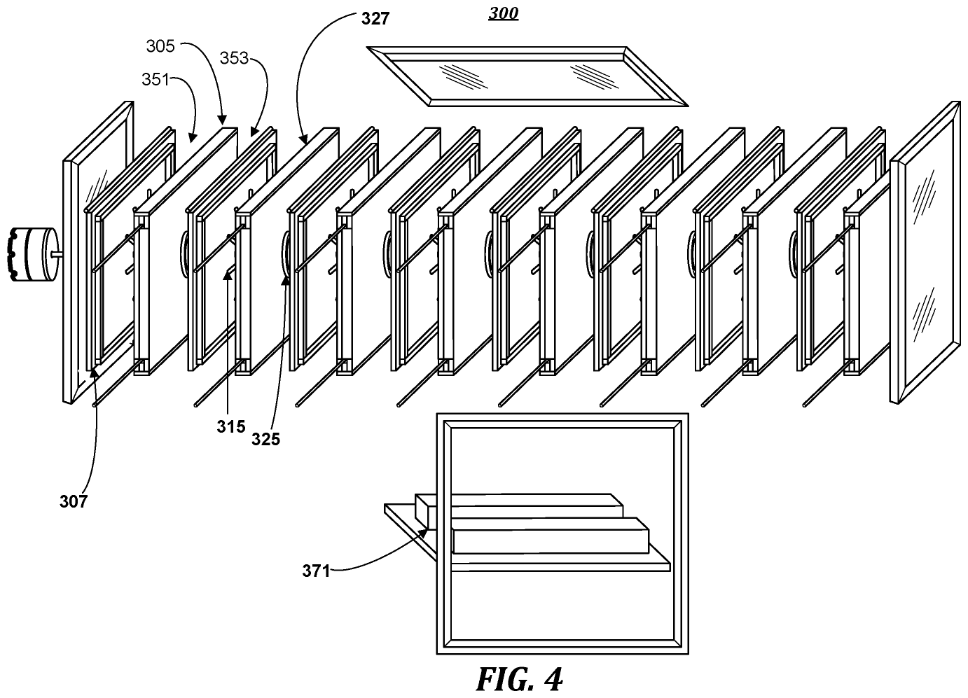

FIGS. 3-4 show various views of another illustrative embodiment of a liquid distillation apparatus 300 in accordance with the present invention. Apparatus 300 includes an external housing 301; a pair of distillation modules 303, each including a cold wall 305 and a warm wall 307; and a circulation system 309 including a motor 311 for driving a rotatable shaft 313 with spokes 315 extending orthogonally out.

FIGS. 1-2 illustrates housing 101 consistent with an embodiment of the disclosure. External housing may be used to house one or more distillation modules, at least a portion of a circulation system, and/or at least a portion of a bottom support structure.

In some embodiments, the external housing may comprise a frame. The frame may be used to provide shape and/or structure to the external housing. The frame may be made from any suitable rigid and/or semi rigid material. In other embodiments, the external housing may comprise one or more walls. The one or more walls may be used to enclose the contents and/or distillation modules within the external housing. Each of the one or more walls may be further configured to secure and/or connect, at least on one edge, to the frame.

The external housing may be embodied as any suitable shape and/or combination of shapes. By way of nonlimiting example, external housing 101 is shown in a rectangular shaped configuration, and comprises one or more of the following external housing walls: a top housing wall, a bottom housing wall, a front housing wall, back housing wall, a left housing wall, and a right housing wall.

In some embodiments, an inner/inside portion of the external housing may comprise a cell wall. The cell wall may be used to assist in facilitating the formation of a vacuum inside the external housing. In other embodiments, the external housing may be constructed or formed such that a vacuum seal may be formed inside the external housing. In further embodiments, the external housing may comprise one or more apertures. The one or more apertures may be used to receive piping and/or other elements connecting to at least a portion of the contents inside the external housing, for example, for moving liquid in and out of the housing. In still further embodiments, the housing may comprise a blast door. The blast door may be used as a support structure to retain integrity of portions of the apparatus and/or provide for a modular access point into the apparatus.

According to further aspects, FIGS. 1-2 illustrate a two distillation module 103 construction consistent with an embodiment of the present disclosure. In still further aspects, each distillation module 103 may comprise a cold wall 105 next to a warm wall 107. Both the cold wall and warm wall have a front side and an opposed back side. The adjacent alternate between cold and warm walls, and the space between the walls may define zones. For example, the warm wall back side and an adjacent cold wall front side defining a first zone 151 therebetween, and the cold wall back side and an adjacent warm wall front side defining a second zone 153 therebetween. For example, zone 151 may be a condensing zone.

FIGS. 3-4 illustrate eight distillation module 303 construction consistent with an embodiment of the present disclosure. In still further aspects, each distillation module 303 may comprise a cold wall 305 next to a warm wall 307. Both the cold wall and warm wall have a front side and an opposed back side. The adjacent alternate between cold and warm walls, and the space between the walls may define zones. For example, the warm wall back side and an adjacent cold wall front side defining a first zone type 351 therebetween, and the cold wall back side and an adjacent warm wall front side defining a second zone 353 therebetween. For example, zone 351 may be a condensing zone. It is noted that the term “cold” may be used to refer to liquid at approximately room temperature and/or any temperature less than room temperature. For example, cold may refer to liquid at about 75 degrees Fahrenheit or less. It is noted that the term “warm” may be used to refer to liquid at about room temperature and/or any temperature greater than room temperature. For example, warm may refer to liquid at about 75 degrees Fahrenheit or more. In other embodiments, the terms warm and cold may be used interchangeably and/or vice-versa.

In yet further aspects, cold wall may be used to introduce cold liquid into the apparatus 100. The cold wall may have a length and/or height proportional to the frame. Further, the cold wall may be positioned relative to the housing to facilitate liquid flow through a gap between the cold wall and at least one of the one or more housing walls. In some embodiments, the cold wall may comprise a cold wall front side. In further embodiments, the cold wall may comprise a cold wall back side. By way of nonlimiting example, the cold wall may be rectangular in shape. It is noted that the cold wall may be any other suitable shape. At least a portion of the cold wall may comprise a rigid or semi rigid lightweight material. In some embodiments, the material may comprise a thermally insulating material and/or a material that is resistant to corrosion by saltwater such as, but not limited to, an expanded polystyrene foam (e.g., Styrofoam). Additionally or alternatively, any other rigid or semi rigid lightweight material may be used to form the cold wall.

In further aspects, cold wall may comprise a cold wall aperture. The cold wall aperture may be used to receive shaft. The cold wall aperture may be further used to house and/or receive at least a portion of a first drift eliminator 115 or 315. The cold wall aperture may be further used to house and/or receive at least a portion of shaft of the circulation system. The cold wall aperture may be positioned substantially in the center of the cold wall. By way of nonlimiting example, the cold wall aperture may be circular in shape. By way of further nonlimiting example, the diameter and/or radius of the cold wall aperture may be approximately ten percent (or between five percent and ninety five percent) of the length of the cold wall. It is noted that the first wall aperture may be any other suitable shape.

In further embodiments, the cold wall may receive or retain at least a portion of the first drift eliminator. The first drift eliminator may be used to separate liquid droplets from gas of liquid vapor formed in the apparatus. The separating of liquid droplets from gas of liquid vapor may be achieved via the liquid vapor traveling upwards into the first drift eliminator, and through a plurality of vertically and/or horizontally overlapping protrusions and/or portions in the first drift eliminator, thereby causing velocity change and/or directional change of the liquid droplets in the liquid vapor, relative to the gas of the liquid vapor. In some embodiments, at least a portion of the first drift eliminator may be disposed within at least a portion of the cold wall aperture. In further embodiments, the first drift eliminator may be disposed flush against the perimeter of the cold wall aperture.

In some embodiments, the first drift eliminator may comprise a first drift eliminator outer portion. In further embodiments, the first drift eliminator may comprise a first drift eliminator inner portion. In some embodiments, the first drift eliminator outer portion may have proportional dimensions to the first drift eliminator inner portion. In further embodiments, the first drift eliminator outer portion may be larger in size than the first drift eliminator inner portion. In further embodiments, at least some of the first drift eliminator inner portion may be secured to the warm wall.

In further embodiments, parts of, and/or at least some of the first drift eliminator may be any suitable shape. In further embodiments, parts of, and/or at least some of the first drift eliminator may be shaped as a hollow cylinder and/or substantially tubular. This shape may be useful to allow the shaft to be guided uninterrupted through the first drift eliminator. In this embodiment, the first drift eliminator inner portion may be disposed within a hollow portion and/or aperture of the first drift eliminator outer portion.

In further embodiments, the cold wall may comprise and/or retain at least a portion of the second drift eliminator. The second drift eliminator 117 or 317 may be used to separate liquid droplets from gas of liquid vapor formed in the apparatus. The separating of liquid droplets from gas of liquid vapor may be achieved via the liquid vapor traveling upwards into the second drift eliminator, and through a plurality of vertically and/or horizontally overlapping protrusions and/or portions in the second drift eliminator thereby causing velocity change and/or directional change of the liquid droplets in the liquid vapor. In some embodiments, the second drift eliminator may comprise a second drift eliminator outer portion. In further embodiments, the second drift eliminator may comprise a second drift eliminator inner portion. In some embodiments, the second drift eliminator outer portion may have proportional dimensions to the second drift eliminator inner portion. In further embodiments, the second drift eliminator outer portion may be larger in size than the second drift eliminator inner portion. In further embodiments, the second drift eliminator outer portion may be disposed about the perimeter of cold wall front side. In further embodiments, the second drift eliminator may be rectangular in shape. In other embodiments, the second drift eliminator may be any other suitable shape.

In further embodiments, at least some of the second drift eliminator inner portion may be secured to a warm wall back side.

In further embodiments, parts of, and/or at least some of the second drift eliminator may be any suitable shape. In further embodiments, parts of, and/or at least some of the second drift eliminator may be substantially rectangular shaped.

In further embodiments, the cold wall may comprise a cold liquid introduction system. The cold liquid introduction system may be used to introduce, distribute, and/or disperse cold liquid onto the cold wall front face. In some embodiments, the cold liquid introduction system may be disposed on a top portion of the cold wall front face. The cold liquid introduction system may be oriented below a top portion of the second drift eliminator inner portion. In some embodiments, the cold liquid introduction system may substantially span the length of the cold wall. In some embodiments, the cold liquid introduction system may secure to a cold wall liquid receptacle piping and/or cold liquid introduction piping configured to supply the cold liquid introduction system with the cold liquid.

In further embodiments, the cold wall may comprise a cold wall liquid receptacle. The cold wall liquid receptacle may be used to receive and/or collect distilled liquid resultant from liquid vapor having droplets being separated from gas therein, the droplets. In some embodiments the cold wall receptacle may comprise the cold wall liquid receptacle piping (alternatively, “cold wall liquid egress system”). At least a portion of the cold wall liquid receptacle piping may be used to recirculate the collected liquid and/or redistribute the collected liquid into the cold liquid introduction system. At least a portion of the cold wall receptacle piping may be used to channel the received liquid (alternatively “waste liquid”) out of the apparatus. At least a portion of the cold wall liquid receptacle piping may be disposed, positioned, and/or secured near the bottom of the cold wall liquid receptacle for ease of liquid flow. In some embodiments, the cold wall liquid receptacle may be positioned between the drift eliminator system and a bottom edge of the front side of the first wall.

In further embodiments, one or more (e.g., each) of the one or more distillation modules may comprise the warm wall. In some embodiments, the warm wall may be formed to have substantially the same size, dimensions, and/or proportions as the cold wall. In some embodiments, the warm wall may be disposed in spatial proximity to the cold wall. The warm wall may be oriented in parallel with and/or on the same plane as the cold wall. The warm wall may be used to introduce warm liquid into the apparatus. The warm wall may have a length and/or height proportional to the frame. Further, the warm wall may be positioned relative to the housing to facilitate liquid flow through a gap between the warm wall and at least one of the one or more housing walls. In some embodiments, the warm wall may comprise a warm wall front side. In further embodiments, the warm wall may comprise a warm wall back side. By way of nonlimiting example, the warm wall may be rectangular in shape. It is noted that the warm wall may be any other suitable shape. At least a portion of the warm wall may comprise a rigid or semi rigid lightweight material. In some embodiments, the material may comprise a thermally insulating material and/or a material that is resistant to corrosion by saltwater such as, but not limited to, an expanded polystyrene foam (e.g., Styrofoam), Additionally or alternatively, any other rigid or semi rigid lightweight material may be used to form the warm wall.

In further embodiments, the warm wall may comprise a warm wall aperture. The warm wall aperture may be used to receive a shaft. The warm wall aperture may be further used to house and/or receive at least a portion of a first drift eliminator. The warm wall aperture may be further used to house and/or receive at least a portion of a shaft of the circulation system. The warm wall aperture may be positioned substantially in the center of the warm wall. By way of nonlimiting example, the warm wall aperture may be circular in shape. By way of further nonlimiting example, the diameter and/or radius of the warm wall aperture may be approximately ten percent (or between five percent and ninety five percent) of the length of the warm wall. It is noted that the first wall aperture may be any other suitable shape.

As previously disclosed, at least some of the second drift eliminator inner portion may be secured to a warm wall front side.

In further embodiments, the warm wall may comprise a warm liquid introduction system. The warm liquid introduction system may be used to introduce, distribute, and/or disperse warm liquid onto the warm wall front face. In some embodiments, warm liquid introduction system may be disposed on a top portion of the warm wall front face. The warm liquid introduction system may be oriented below a top portion of the second drift eliminator inner portion. In some embodiments, the warm liquid introduction system may substantially span the length of the warm wall. In some embodiments, the warm liquid introduction system may secure to a warm wall liquid receptacle piping and/or warm liquid introduction piping configured to supply the warm liquid introduction system with the warm liquid.

In further embodiments, the warm wall may comprise a warm wall liquid receptacle. The warm wall liquid receptacle may be used to receive and/or collect liquid resultant from the warm wall liquid introduction system. In some embodiments the warm wall receptacle may comprise the warm wall liquid receptacle piping (alternatively, “warm wall liquid egress system”). At least a portion of the warm wall liquid receptacle piping may be used to recirculate the collected liquid and/or redistribute the collected liquid into the warm liquid introduction system. At least a portion of the warm wall receptacle piping may be used to channel the received liquid (alternatively “waste liquid”) out of the apparatus. At least a portion of the warm wall liquid receptacle piping may be disposed, positioned, and/or secured near the bottom of the warm wall liquid receptacle for ease of liquid flow. In some embodiments, the warm wall liquid receptacle may be positioned between the drift eliminator system and a bottom edge of the front side of the first wall.

FIGS. 2 and 4 illustrate the circulation system consistent with an embodiment of the disclosure. The circulation system may be used to circulate liquid droplets and/or vapor. The circulator may be further used to exert a torque, spin, and/or shear force to the liquid droplets being introduced by the cold liquid introduction system. The circulation system may further be used to increase number the collisions of gas molecules.

In some embodiments, the circulation system may have two distinct circulation modules for fluids such as, but not limited to, a first circulation module for cold liquid, and a second circulation module for warm liquid. It is noted that both the first circulation module for cold liquid and/or the second circulation module for warm liquid may be embodied as at least a portion of the following described circulation system.

In some embodiments, the circulation system may comprise a shaft (alternatively, “rotor”). The shaft may be used to receive, house, and/or mount one or more circulators. in embodiments, the shaft may be used to rotate the one or more circulators. The shaft may be secured to a motor. In some embodiments, a portion of the shaft may be housed outside the housing and/or inside the housing. By way of nonlimiting example, the shaft may span through the blast door, a back housing wall aperture, the cold wall aperture, the warm wall aperture, and/or a front housing wall aperture. A portion of the shaft may be further configured to be secured through one of the one or more apertures of the housing, thereby guiding a portion of the shaft into/inside the housing.

In further embodiments, the circulation system may comprise the one or more circulators. In some embodiments, each of the one or more circulators may be oriented and/or disposed between the cold wall front side and the warm wall back side. In further embodiments, each of the one or more circulators may be oriented and/or disposed flush against the warm wall back side. The one or more circulators may be configured to rotate in a predetermined direction. The one or more circulators may be configured to use shear forces to collapse the vapor. The one or more circulators may comprise a plurality of protrusions (alternatively “spokes”). A first end of each of the plurality of protrusions may be secured to the shaft. Each of the plurality of protrusions may be disposed orthogonally from the shaft, so as to extend radially outward therefrom. In some embodiments, the length of each of the plurality of protrusions may be substantially half the length of the cold wall and/or the warm wall.

In further embodiments, the circulation system may comprise a motor. The motor may be embodied as any system capable of exerting a torque. The motor may be configured to rotate and/or drive the shaft and/or the one or more circulators in a predetermined direction. In some embodiments, the motor may be in operative communication with a computing device. The computing device may be used to control operations of the motor and/or other operations relating to the apparatus and/or methods thereof.

FIGS. 2 and 4 illustrate the bottom support structure 171 or 371 consistent with an embodiment of the disclosure. The bottom support structure may be used to provide structural support to the one or more distillation modules. In some embodiments, the bottom support structure may include one or more bases, abutments, columns, blocks, and or any other suitable support structures. In other embodiments, the bottom support structure may include two rectangular columns spanning horizontally and contacting at least a portion of each of the one or more distillation modules.

In some embodiments, the bottom support structure may span underneath the one or more distillation modules. In some embodiments, the bottom support structure may be made from a rigid and/or semi-rigid material. The bottom support structure may be an intermediary between the one or more distillation modules and the bottom housing wall.

### III. Apparatus/System Operation and Methods for Use

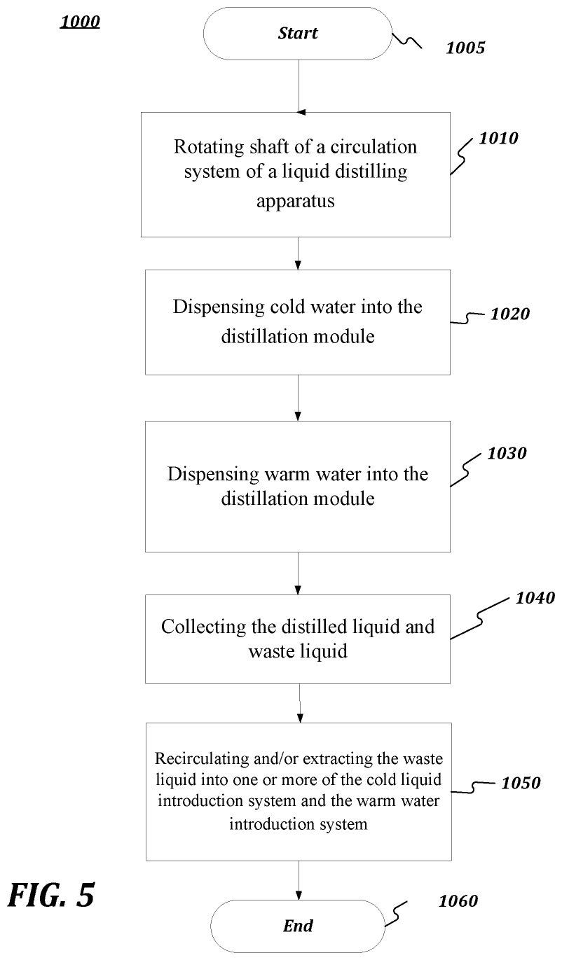

Also disclosed herein are methods of using the disclosed devices and systems. For example, in another illustrative aspect, the present disclosure provides a method for distilling liquid using a disclosed apparatus or system. FIG. 5 is a flow chart setting forth the general stages involved in a method 1000 consistent with an embodiment of the disclosure for producing a distilled water from contaminated water using a disclosed distillation apparatus or system. Method 1000 may be implemented using, at least in part, apparatus 100 and apparatus 300. Although stages are disclosed with reference to apparatuses 100 and 300, it should be understood that other disclosed embodiments may enable the operation of method 1000, including, but not limited to, other mechanisms, mechanical components, environment properties, user conditions, and the like. Further still, although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Method 1000 may begin at starting block 1005 and proceed to stage 1010, where torque is exerted on a shaft of a circulation system of a liquid distilling apparatus, the torque on the shaft causing the shaft and one or more circulators secured to the shaft to rotate. By way of non-limiting example, the following may be present: each of the one or more circulators is disposed between a cold wall front side of a cold wall and the warm wall back side of a warm wall; the warm wall, the cold wall, a portion of the shaft, and the one or more circulators are disposed within an external housing of the apparatus; the external housing forms a vacuum seal within the external housing; each of the one or more circulators comprises a plurality of protrusions; each of the plurality of protrusions is dimensioned to be half the length of the warm wall; and each of the plurality of protrusions is oriented orthogonally from the shaft.

From stage 1010, where the shaft of the circulation system is rotated, method 1000 may proceed to stage 1020 where cold water is dispensed into the distillation module. Dispensing may include: actuating one or more cold liquid sources or introduction systems of one or more distillation modules, each of the one or more cold liquid introduction systems being disposed at top portion of the cold wall front side; pumping cold liquid from an external reservoir into the cold liquid introduction system, and dispersing, percolating, and/or discharging the cold liquid, through a plurality of apertures of the cold liquid introduction system, such that the dispersed cold liquid flows onto the cold wall front side in a downward direction. Alternatively, the cold liquid may be sprayed in the central area outward.

From stage 1020, where cold water is dispensed into the distillation module, method 1000 may proceed to stage 1030, where warm water is dispensed into the distillation module. Dispensing can include: actuating one or more warm liquid sources or introduction systems of one or more distillation modules, each of the one or more warm liquid introduction systems being disposed at top portion of the warm wall front side; pumping warm liquid from an external reservoir into the warm liquid introduction system, and dispersing, percolating, and/or discharging the warm liquid, through a plurality of apertures of the warm water introduction system, such that the dispersed warm liquid flows onto the warm wall front side in a downward direction. In some aspects, actuating one or more warm liquid introduction systems can causes a heat exchange between cold liquid vapor formed from the rotating circulation system with the one or more cold liquid introduction systems and warm liquid vapor formed from the one or more warm liquid introduction systems.

From stage 1030, where warm water is dispensed into the distillation module, method 1000 may proceed to stage 1040, where the distilled liquid and waste water is collected. Here, distilled liquid, via a distilled liquid receptacle disposed below a bottom edge of the cold wall, resultant from liquid droplets being separated from liquid vapor via the liquid vapor navigating through a plurality of drift eliminator systems, the plurality of drift eliminator systems comprising: One or more first drift eliminators, at least a portion of each of the one or more drift eliminators being disposed in an aperture of the warm wall and the cold wall, each of the one or more drift eliminators comprises a plurality of tubular portions overlapping one another; One or more second drift eliminators disposed about the perimeter of the of cold wall front side and the warm wall back side; each of the one or more drift eliminators comprises a plurality of rectangular portions overlapping one.

The waste liquid may be collected via a waste liquid receptacle disposed below a bottom edge of the warm wall, resultant from liquid droplets being condensed and/or nonevaporated liquid; the waste liquid receptacle is secured to piping configured to direct the waste liquid out of the apparatus and/or recirculate the waste liquid.

From stage 1040, where distilled product and waste liquid has been collected, method 1000 may proceed to stage 1050, where recirculating and/or extracting the waste liquid into one or more of the cold liquid introduction system and the warm water introduction system. After stage 1050 where the distilled product may be stored, method 1000 may end at stage 1060.

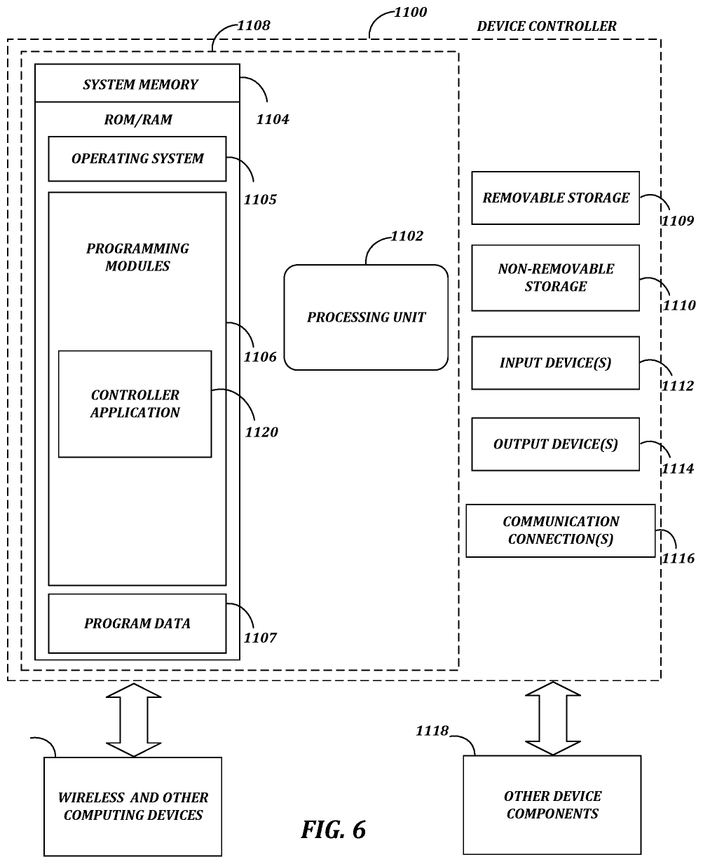

FIG. 6 is a block diagram of a system including controller 1100. Consistent with an embodiment of the disclosure, operation of portions of the disclosed apparatuses, memory storage and processing unit may be implemented in a computing device, such as controller 1100. Any suitable combination of hardware, software, or firmware may be used to implement the memory storage and processing unit. For example, operation of portions of the disclosed apparatuses, memory storage and processing unit may be implemented with controller 1100 or any of the modules, units, sensors, and device components 1118, or any other control unit and wireless devices 1122, in combination with controller 1100. Other device components 1118 may comprise, for example, but not be limited to, control mechanisms, modules, sensors, switches, communication module, power source, power regulator, various transceivers and antennas. The aforementioned system, device, and processors are examples and other systems, devices, and processors may comprise the aforementioned memory storage and processing unit, consistent with embodiments of the disclosure.

With reference to FIG. 6, a system consistent with an embodiment of the disclosure may include a computing device, such as controller 1100. In a basic configuration, controller 1100 may include at least one processing unit 1102 and a system memory 1104. Depending on the configuration and type of computing device, system memory 1104 may comprise, but is not limited to, volatile (e.g., random access memory (RAM)), non-volatile (e.g., read-only memory (ROM)), flash memory, or any combination. System memory 1104 may include operating system 1105, one or more programming modules 1106, and may include a program data 1107. Operating system 1105, for example, may be suitable for controlling controller 1100's operation. In one embodiment, programming modules 1106 may include controller application (“app”) 1120. Furthermore, embodiments of the disclosure may be practiced in conjunction with a graphics library, other operating systems, or any other application program and is not limited to any particular application or system. This basic configuration is illustrated in FIG. 6 by those components within a dashed line 1108. In further aspects, the app may provide a user with information as well as be the user's interface to operating the embodiment of the invention. The app may include one or more graphic user interfaces (GUIs). Among the GUIs of the app may be a GUI allowing the user to pick which, if there is more than one, team display to activate, and to select (if available) one or more operating parameters or characteristics of the device. The user may be able to adjust such selections without having to deactivate the embodiment from a GUI of the app. The user may also use the app to turn on and turn off the device components. The app may also present the user with information received from the device components, such as environmental and telemetry data from the sensors. In some embodiments, the GUI may be presented on an LCD screen integrated in the device housing.

Controller 1100 may have additional features or functionality. For example, controller 1100 may also include additional data storage devices (removable and/or non-removable) such as, for example, magnetic disks, optical disks, or tape. Such additional storage is illustrated in FIG. 6 by a removable storage 1109 and a non-removable storage 1110. Computer storage media may include volatile and nonvolatile, removable and non-removable media implemented in any method or technology for storage of information, such as computer readable instructions, data structures, program modules, or other data. System memory 1104, removable storage 1109, and non-removable storage 1110 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by controller 1100. Any such computer storage media may be part of device 1100. Controller 1100 may also be operative with input device(s) 1112 such as a keyboard, a mouse, a pen, a sound input device, a touch input device (e.g., an integrated LCD screen), etc. Input device(s) 1112 may be used to, for example, manually access and program controller 1100. Output device(s) 1114 such as a display, speakers, a printer, etc. may also be included. The aforementioned devices are examples and others may be used.

Controller 1100 may also contain a communication connection 1116 that may allow device 1100 to communicate with other control units and wireless devices 1122 as well as vibration source, thermal elements, and other components 1118 (e.g., transceivers, sensors, thermal elements), such as over an encrypted network in a distributed computing environment. Communication connection 1116 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, Bluetooth, radio frequency (RF), infrared, and other wireless media. The term computer readable media as used herein may include both storage media and communication media. As stated above, a number of program modules and data files may be stored in system memory 1104, including operating system 1105. While executing on processing unit 1102, programming modules 1106 (e.g., controller application 1120) may perform processes including, for example, one or more of stages or portions of stages of method 1000 as described above. App 1120 may be configured to operate device components 1118 and receive instructions from, for example, communications connections module 1116. The aforementioned process is an example, and processing unit 1102 may perform other processes.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Although the stages are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed without altering or deterring from the fundamental scope of the depicted methods and systems disclosed herein.

### IV. Aspects

The following disclose various Aspects of the present disclosure. The various Aspects are not to be construed as patent claims unless the language of the Aspect appears as a patent claim. The Aspects describe various non-limiting embodiments of the present disclosure.
Aspect 1. The apparatus is essentially a hurricane on its side.
Aspect 2. Material of the walls should be non-corrosive against salt water.
Aspect 3. The cold water/wall acts as a condenser.
Aspect 4. The spokes/protrusions increase number the collisions of gas molecules.
Aspect 5. A cooling tower may be required. A cooling tower may be a device that rejects waste heat to the atmosphere through the cooling of a coolant stream. Some examples of cooling towers are, crossflow, counterflow, hyperbolic, induced draft, and passive draft.
Aspect 6. Spokes/protrusions can be rigid, semi-rigid, and/or pliable.
Aspect 7. Drift eliminators (alternatively, “velocity dampening systems”) may be used and disposed flush about the inside of the external housing.
Aspect 8. Each layer is buffered from the next with a drift eliminator around the outer and the inner gaps.
Aspect 9. Apparatus may use shear forces to collapse the vapor in order to increase collisions instead of propelling it.
Aspect 10. Apparatus may use water as a heat sink instead of cooling coils.

### V. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A liquid distillation apparatus comprising:
one or more liquid distillation modules, each liquid distillation module comprising:
a one cold wall having a front side and an opposed back side positioned adjacent to a warm wall having a front side and an opposed back side; the warm wall back side and an adjacent cold wall front side defining a first zone therebetween, and the cold wall back side and an adjacent warm wall front side defining a second zone therebetween;
a first drift eliminator arrangement including inner and outer drift eliminator portions, the first drift eliminator arrangement positioned in the first zone;
a secondary drift eliminator arrangement including inner and outer drift eliminator portions, the secondary drift eliminator arrangement positioned in the second zone;
a cold liquid source configured to disperse cold liquid onto a cold wall front face;
a warm liquid source being configured to disperse warm liquid onto the warm wall front face;
a distilled liquid receptacle configured to collect distilled liquid resultant from liquid droplets being separated from liquid vapor, the liquid vapor having navigated through the first drift eliminator arrangement and the second drift eliminator,
a waste liquid receptacle configured to collect a waste liquid resultant of non-distilled liquid;
a circulation system comprising:
a shaft disposed through each of the one or more distillation modules;
a plurality of protrusions evenly distributed on one plane and disposed orthogonally on the shaft, and
a motor configured to exert a rotational force on the shaft,
wherein rotation of the shaft causes the following:
a shear force exerted on liquid encountering one of the rotating protrusions,
a heat exchange facilitated by the circulation and/or between cold liquid vapor formed from the rotating protrusion of the circulation system with the cold liquid source and warm liquid vapor formed from the warm liquid source; and
an external housing containing:
the one or more liquid distillation modules, and
the shaft, and
the plurality of protrusions.

2. The apparatus of claim 1, wherein the cold wall is substantially rectangular in shape.

3. The apparatus of claim 2, wherein the warm wall is substantially rectangular in shape.

4. The apparatus of claim 3, further comprising a cold liquid introduction piping configured to supply the cold liquid introduction system with the cold liquid.

5. The apparatus of claim 4, further comprising a cold liquid introduction piping configured to supply the cold liquid introduction system with the cold liquid.

6. The apparatus of claim 5, further comprising a blast door on one side of the external housing.

7. The apparatus of claim 6, further comprising a cold wall aperture between five percent and ninety five percent of the length of the cold wall.

8. The apparatus of claim 7, further comprising a warm wall aperture equal to ten percent of the length of the warm wall.

9. The apparatus of claim 8, wherein the cold liquid source comprises a cold liquid introduction system configured to disperse cold liquid onto the cold wall front face.

10. The apparatus of claim 9, wherein the warm liquid source comprises a warm liquid introduction system spanning a top edge of the warm wall front side, the warm liquid introduction system being configured to disperse warm liquid onto the warm wall front face.

11. The apparatus of claim 10, wherein the first zone comprises a condensing zone.

12. The apparatus of claim 10, wherein the second zone comprises a condensing zone.

13. A liquid distillation apparatus comprising:
one or more liquid distillation modules, each liquid distillation module comprising:
a cold wall comprising:
a cold wall aperture oriented in the middle of the cold wall,
a cold wall back side comprising a first drift eliminator outer portion dimensioned proportionally to the cold wall aperture and spanning the perimeter of the cold wall aperture, and
a cold wall front side comprising a second drift eliminator outer portion dimensioned proportionally to the cold wall and spanning the perimeter of the cold wall,
a cold liquid source comprising cold liquid introduction system spanning a top edge of the cold wall front side, the cold liquid introduction system being configured to disperse cold liquid onto the cold wall front face,
a distilled liquid receptacle spanning a bottom edge of the cold wall front side, the distilled liquid receptacle being configured to receive distilled liquid resultant from liquid droplets being separated from liquid vapor, the liquid vapor having navigated through one or more of the first drift eliminator and the second drift eliminator,
a warm wall comprising:
a warm wall aperture oriented in the middle of the warm wall, the warm wall aperture housing a first drift eliminator outer portion,
a warm wall front side, and
a warm wall back side comprising a second drift eliminator inner portion dimensioned proportionally smaller than the second drift eliminator outer portion and spanning an inner perimeter of the warm wall;
a warm liquid source comprising a warm liquid introduction system spanning a top edge of the warm wall front side, the warm liquid introduction system being configured to disperse warm liquid onto the warm wall front face,
a waste liquid receptacle spanning a bottom edge of the warm wall front side, the waste liquid receptacle being configured to receive a waste liquid resultant of non-distilled water collecting at the bottom of the apparatus;
a circulation system comprising:
a shaft disposed through the following:
each of the cold wall apertures,
each of the warm wall apertures, and
for each of the one or more liquid distillation modules, a plurality of protrusions evenly distributed on one plane and disposed orthogonally on the shaft,
a motor configured to exert a rotational force on the shaft,
wherein rotation of the shaft causes the following:
a shear force exerted on liquid encountering one of the rotating protrusions,
a heat exchange facilitated by the circulation and/or between cold liquid vapor formed from the rotating circulation system with the one or more cold liquid introduction systems and warm liquid vapor formed from the one or more warm liquid introduction systems; and
an external housing enveloping the following:
the one or more liquid distillation modules, and
the shaft, and
the plurality of protrusions.

14. The apparatus of claim 13, wherein the cold wall is substantially rectangular in shape.

15. The apparatus of claim 14, wherein the warm wall is substantially rectangular in shape.

16. The apparatus of claim 15, wherein the diameter of the cold wall aperture is between five percent and ninety five percent of the length of the cold wall.

17. The apparatus of claim 16, wherein the diameter of the warm wall aperture is ten percent of the length of the warm wall.

18. The apparatus of claim 17, further comprising a cold liquid introduction piping configured to supply the cold liquid introduction system with the cold liquid.

19. The apparatus of claim 18, further comprising a cold liquid introduction piping configured to supply the cold liquid introduction system with the cold liquid.

20. The apparatus of claim 19, further comprising a blast door on one side of the external housing.
